(19) United States
(12) Patent Application Publication
(10) Pub. No.: US 2024/0263264 A1
(43) Pub. Date: Aug. 8, 2024

(54) CONTINUOUS HEATING DEVICE AND CONTINUOUS HEATING METHOD

(71) Applicant: METAL INDUSTRIES RESEARCH & DEVELOPMENT CENTRE, KAOHSIUNG (TW)

(72) Inventors: Yi-San CHANG, TAINAN CITY (TW); Chang-Sin YE, Tainan City (TW); Jing-Shiang SHIH, Kaohsiung City (TW)

(21) Appl. No.: 18/352,258

(22) Filed: Jul. 14, 2023

(30) Foreign Application Priority Data
Feb. 4, 2023 (TW) 112103989

(51) Int. Cl. C21D 8/10; C21D 9/08

(52) U.S. Cl. CPC C21D 8/10; C21D 9/085; F27B 7/08

(57) ABSTRACT

A continuous heating device includes a first and a second linear actuators, a first and a second rotating mechanisms, a first gas introduction mechanism, and heating modules. The first linear actuator linearly can drive a metal tube towards a heating zone. The metal tube has a first and a second end portions opposite to each other. The first rotating mechanism can clamp the first end portion to rotate in the heating zone. The first gas introduction mechanism can supply a process gas into the metal tube from the first end portion. The heating modules are arranged sequentially in the heating zone. Each heating module can heat the metal tube at an individual heating temperature. The second rotating mechanism can clamp the second end portion to rotate in the heating zone and a discharging zone. The second linear actuator can linearly move the metal tube away from the heating zone.

### RELATED APPLICATIONS

This application claims priority to Taiwan application Serial Number 112103989, filed Feb. 4, 2023, which is herein incorporated by reference.

### BACKGROUND

### Field of Invention

The present disclosure relates to a heating technology, and more particularly, to a continuous heating device and a continuous heating method.

### Description of Related Art

A sintered porous surface tube is a kind of enhanced boiling heat transfer product. The enhanced boiling heat transfer refers to convective heat transfer when a boiling fluid is forced to flow in a tube, and is often applied to devices such as evaporators, tubular stills, steam boilers, and nuclear reactors. The sintered porous surface tube is manufactured by high-temperature sintering to form a porous metal layer on an inner surface of a smooth tube.

Currently, the sintering process of the sintered porous surface tube is performed in a closed horizontal furnace. Before the sintering process, the furnace needs to be vacuumed, which is time-consuming and increases the cost of the process. In addition, a length of the closed horizontal furnace limits a length of the porous surface tube that can be sintered. Furthermore, a constant temperature zone in the closed horizontal furnace is small, such that the length of the porous surface tube that can be sintered is more limited, the energy waste of the sintering furnace is caused, and the uniformity and the strength of the porous surface tube are poor.

### SUMMARY

Therefore, one objective of the present disclosure is to provide a continuous heating device and a continuous heating method, in which a feeding zone and a discharging zone are both provided with independently driven linear actuators and rotating mechanisms, the two rotating mechanisms can continuously rotate a metal tube in a heating zone, and the two linear actuators can sequentially transport the metal tube. Thus, the feeding, heating, and discharging of the metal tube can be carried out continuously, so the efficiency of a heating treatment of the metal tube can be greatly enhanced.

Another objective of the present disclosure is to provide a continuous heating device and a continuous heating method, which can perform a multi-stage heating treatment on the metal tube, such that a heating graph of the heating zone can be flexibly set to provide a large constant temperature zone. With a specific heating graph, high-speed heating and proper cooling after heating can be achieved, such that the energy utilization efficiency can be enhanced, the heating efficiency and throughput can be increased, and a porous surface metal tube with high heat transferring quality can be obtained.

Still another objective of the present disclosure is to provide a continuous heating device, which is a non-furnace open heating device, such that no vacuum treatment is required, and a heating length of the metal tube is not limited by a length of a furnace, which can shorten the process time and reduce the process cost.

According to the above objectives, the present disclosure provides a continuous heating device, which is at least divided into a feeding zone, a heating zone, and a discharging zone which are sequentially arranged. The continuous heating device includes a first linear actuator, a first rotating mechanism, a first gas introduction mechanism, plural heating modules, a second rotating mechanism, and a second linear actuator. The first linear actuator is disposed in the feeding zone, and is configured to drive a metal tube linearly towards the heating zone. The metal tube has a first end portion and a second end portion, which are opposite to each other. The first rotating mechanism is disposed in the feeding zone, and is configured to clamp the first end portion of the metal tube and to drive the metal tube to rotate on the first linear actuator and in the heating zone. The first gas introduction mechanism is disposed in the feeding zone and is configured to supply a process gas into the metal tube from the first end portion of the metal tube. The heating modules are arranged sequentially in the heating zone. Each of the heating modules is configured to heat the metal tube at an individual heating temperature in the heating zone. The second rotating mechanism is disposed in the discharging zone, and is configured to clamp the second end portion of the metal tube transported from the heating zone by the first rotating mechanism and to drive the metal tube to rotate in the heating zone and the discharging zone. The second linear actuator is disposed in the discharging zone, and is configured to drive the metal tube linearly away from the heating zone.

According to one embodiment of the present disclosure, each of the first linear actuator and the second linear actuator includes a linear sliding rail and a drive motor. The drive motor is connected to the linear sliding rail to drive the linear sliding rail to drive the metal tube. Each of the first rotating mechanism and the second rotating mechanism includes a tube clamping mechanism and a rotary actuator. The rotary actuator is connected to the tube clamping mechanism to drive the tube clamping mechanism to rotate, and the tube clamping mechanism is configured to clamp the metal tube and to drive the metal tube to rotate.

According to one embodiment of the present disclosure, each of the heating modules includes an induction heating coil and a power supply device. The power supply device is electrically connected to the induction heating coil. Each of the heating module heats the metal tube at the individual heating temperature through adjusting a current applied to the induction heating coil by the power supply device.

According to one embodiment of the present disclosure, the current is a high-frequency current with a frequency of 10 Hz to 200 kHz.

According to one embodiment of the present disclosure, the continuous heating device further includes plural first deformation suppression modules located in the heating zone. The first deformation suppression modules are respectively disposed between the heating modules, and between the feeding zone and the heating module adjacent to the feeding zone, so as to suppress deformation of the metal tube.

According to one embodiment of the present disclosure, each of the first deformation suppression modules includes a first roller set and a second roller set arranged in sequence. The first roller set is configured to apply a first suppression force on the metal tube, and the second roller set is configured to apply a second suppression force on the metal tube. A direction of the first suppression force is substantially perpendicular to a direction of the second suppression force.

According to one embodiment of the present disclosure, the continuous heating device further includes plural temperature sensors disposed in the heating zone, or in the heating zone and the discharging zone, to detect a temperature of the metal tube.

According to one embodiment of the present disclosure, the continuous heating device further includes a blowing module disposed in the discharging zone, in which the blowing module is configured to reduce a temperature of the metal tube.

According to the above objectives, the present disclosure provides a continuous heating method. In this method, a metal tube is transported from a feeding zone to a heating zone and a discharging zone sequentially. Transporting the metal tube to the heating zone and the discharging zone sequentially includes rotating the metal tube with a central axis of the metal tube as a rotation axis. A process gas is supplied into the metal tube from a first end portion of the metal tube during transporting the metal tube. A multi-stage heating treatment is performed on the metal tube in the heating zone to heat the metal tube at plural heating temperatures so as to perform a sintering process on a metal material layer coated on an inner surface of the metal tube. A cooling treatment is performed on the metal tube in the discharging zone.

According to one embodiment of the present disclosure, a rotating speed of rotating the metal tube is about 0.1 rpm to about 1000 rpm.

According to one embodiment of the present disclosure, the process gas includes an inert gas and/or a redox gas.

According to one embodiment of the present disclosure, performing the multi-stage heating treatment includes heating the metal tube by using plural heating modules, and controlling heating temperatures of the heating modules individually.

According to one embodiment of the present disclosure, each of the heating modules includes an induction heating coil and a power supply device electrically connected to the induction heating coil. Performing the multi-stage heating treatment includes: detecting a temperature of the metal tube to obtain plural temperature signals by using plural temperature sensors; receiving the temperature signals by using a control device; and adjusting a current applied by each of the power supply devices to the induction heating coil by the control device according to the temperature signals.

According to one embodiment of the present disclosure, performing the multi-stage heating treatment includes performing plural first deformation suppression treatments on the metal tube.

According to one embodiment of the present disclosure, the continuous heating method further includes performing plural second deformation suppression treatments on the metal tube in the discharging zone.

### BRIEF DESCRIPTION OF THE DRAWINGS

Aspects of the present disclosure are best understood from the following detailed description in conjunction with the accompanying figures. It is noted that in accordance with the standard practice in the industry, various features are not drawn to scale. In fact, dimensions of the various features can be arbitrarily increased or reduced for clarity of discussion.

FIG. 1 is a schematic diagram of a continuous heating device in accordance with one embodiment of the present disclosure.

FIG. 2 is a schematic three-dimensional diagram of a first deformation suppression module in accordance with one embodiment of the present disclosure.

FIG. 3 is a schematic cross-sectional view of a first roller set of a first deformation suppression module in accordance with one embodiment of the present disclosure.

FIG. 4 is a schematic cross-sectional view of a second roller set of a first deformation suppression module in accordance with one embodiment of the present disclosure.

FIG. 5 is a diagram showing a temperature variation graph of a metal tube in accordance with one embodiment of the present disclosure.

### DETAILED DESCRIPTION

The embodiments of the present disclosure are discussed in detail below. However, it will be appreciated that the embodiments provide many applicable concepts that can be implemented in various specific contents. The embodiments discussed and disclosed are for illustrative purposes only and are not intended to limit the scope of the present disclosure. All of the embodiments of the present disclosure disclose various different features, and these features may be implemented separately or in combination as desired.

In addition, the terms “first”, “second”, and the like, as used herein, are not intended to mean a sequence or order, and are merely used to distinguish elements or operations described in the same technical terms. Furthermore, the spatial relationship between two elements described in the present disclosure applies not only to the orientation depicted in the drawings, but also to the orientations not represented by the drawings, such as the orientation of the inversion.

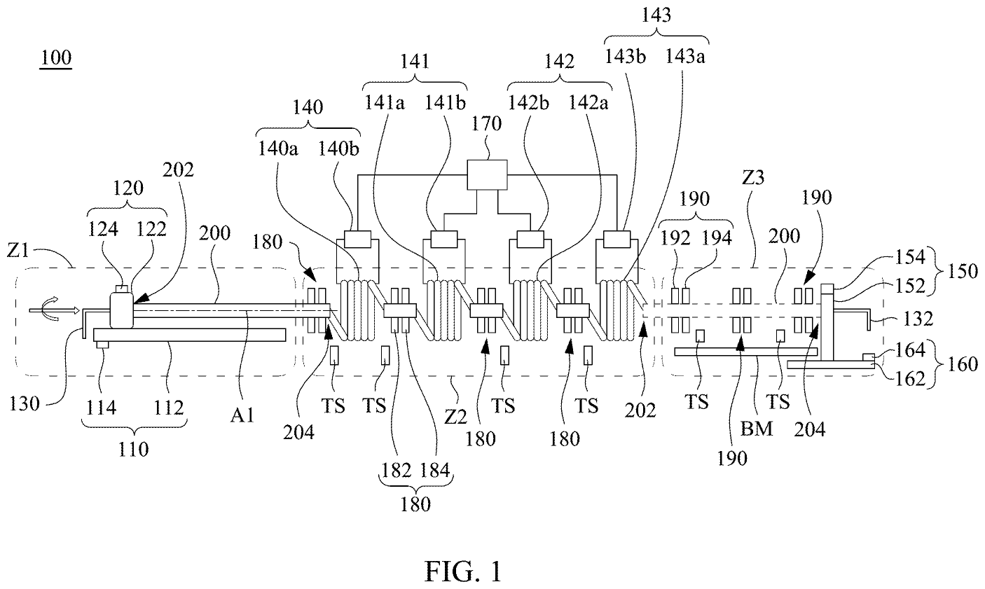

Referring to FIG. 1, FIG. 1 is a schematic diagram of a continuous heating device in accordance with one embodiment of the present disclosure. A continuous heating device 100 is an open heating device, which may be used, for example, to heat a metal tube 200. For example, the continuous heating device 100 may heat the metal tube 200, and perform a sintering process on a metal material layer coated within the metal tube 200, so as to obtain a porous surface tube. The metal tube 200 has a first end portion 202 and a second end portion 204, which are opposite to each other. The continuous heating device 100 may at least be divided into a feeding zone Z1, a heating zone Z2, and a discharging zone Z3, which are sequentially arranged. That is, the heating zone Z2 is located between the feeding zone Z1 and the discharging zone Z3. The metal tube 200 enters the continuous heating device 100 from the feeding zone Z1, and after being heated in the heating zone Z2, moves out of the continuous heating device 100 from the discharging zone Z3.

The continuous heating device 100 may mainly include a first linear actuator 110, a first rotating mechanism 120, a first gas introduction mechanism 130, plural heating modules 140 to 143, a second rotating mechanism 150, and a second linear actuator 160. The first linear actuator 110 is disposed in the feeding zone Z1. The first linear actuator 110 can carry the metal tube 200 and linearly drive the metal tube 200 in a direction toward the heating zone Z2. In some examples, the first linear actuator 110 includes a linear sliding rail 112 and a drive motor 114. The linear sliding rail 112 can carry the metal tube 200. The drive motor 114 is connected to the linear sliding rail 112 and can drive the linear sliding rail 112 to drive the metal tube 200 disposed thereon.

The first rotating mechanism 120 is also disposed in the feeding zone Z1. The first rotating mechanism 120 may be used to clamp the first end portion 202 of the metal tube 200 and drive the metal tube 200 to rotate on the first linear actuator 110 and in the heating zone Z2. In some examples, the first rotating mechanism 120 includes a tube clamping mechanism 122 and a rotary actuator 124. The tube clamping mechanism 122 can clamp the first end portion 202 of the metal tube 200. The rotary actuator 124 is connected to the tube clamping mechanism 122 to drive the tube clamping mechanism 122 to rotate. For example, the rotary actuator 124 may be a motor, and may drive the tube clamping mechanism 122 to rotate through a belt or a gear. The rotation of the tube clamping mechanism 122 can drive the metal tube 200 to rotate around a central axis A1, that is, the tube clamping mechanism 122 can drive the metal tube 200 to revolve on its own axis. The first rotating mechanism 120 may be disposed on the linear sliding rail 112 of the first linear actuator 110 and may be driven by the linear sliding rail 112, for example. Accordingly, the metal tube 200 can move linearly into the heating zone Z2 while rotating.

The first gas introduction mechanism 130 is disposed in the feeding zone Z1. The first gas introduction mechanism 130 can supply a process gas required for a heating treatment into the metal tube 200 from the first end portion 202 of the metal tube 200. The first gas introduction mechanism 130 may be, for example, a gas conduit.

The heating modules 140 to 143 are arranged in sequence in the heating zone Z2. The heating modules 140 to 143 may be arranged at a constant interval. However, the heating modules 140 to 143 may also have different pitches. In the example shown in FIG. 1, four heating modules 140 to 143 are provided in the heating zone Z2, but this is only for illustration, and the heating zone Z2 may be provided with less than or more than four heating modules according to the site and/or the process requirements.

Each of the heating modules 140 to 143 may heat the metal tube 200 at an individual heating temperature in the heating zone Z2. The individual heating temperatures of the heating modules 140 to 143 may be different from each other, or may not be quite different. For example, the individual heating temperatures of the heating modules 140 and 143 may both be different from the individual heating temperatures of the middle heating modules 141 and 142, in which the individual heating temperatures of the heating modules 141 and 142 may be the same or different from each other, and the individual heating temperatures of the heating modules 140 and 143 may be the same or different from each other. Thus, the heating modules 140 to 143 may perform a multi-stage heating treatment on the metal tube 200 according to a predetermined heating graph.

In some examples, the heating modules 140 to 143 respectively include induction heating coils 140a to 143a, and corresponding power supply devices 140b to 143b. The power supply devices 140b to 143b are respectively electrically connected to the corresponding induction heating coils 140a to 143a to individually supply power to the induction heating coils 140a to 143a, such that the induction heating coils 140a to 143a are heated by electromagnetic induction. By individually adjusting the current supplied by the power supply devices 140b to 143b, temperatures of the induction heating coils 140a to 143a can be independently controlled. In the heating zone Z2, the metal tube 200 can pass through the induction heating coils 140a to 143a in sequence and be heated by the induction heating coils 140a to 143a.

The continuous heating device 100 may optionally include a control device 170. The control device 170 may be connected to the power supply devices 140b to 143b for signals through wired or wireless transmission. The control device 170 can independently control the current applied by the power supply devices 140b to 143b to the corresponding induction heating coils 140a to 143a.

The second rotating mechanism 150 is disposed in the discharging zone Z3. The second rotating mechanism 150 may be used to clamp the metal tube 200 transported by the first rotating mechanism 120 through the heating zone Z2. Specifically, the first rotating mechanism 120 clamps the first end portion 202 of the metal tube 200, and the opposite second end portion 204 passes through the heating zone Z2 and enters the discharging zone Z3 while driven by the first linear actuator 110. At this moment, the first rotating mechanism 120 releases the first end portion 202, and the second rotating mechanism 150 clamps the second end portion 204. Accordingly, the first rotating mechanism 120 and the second rotating mechanism 150 can sequentially hold the metal tube 200. In some examples, when the metal tube 200 entirely enters the heating zone Z2, the first rotating mechanism 120 in the feeding zone Z1 releases the metal tube 200, and the second rotating mechanism 150 in the discharging zone Z3 clamps the metal tube 200 instead.

The second rotating mechanism 150 can drive the metal tube 200 to rotate in the heating zone Z2 and the discharging zone Z3. In some examples, the second rotating mechanism 150 includes a tube clamping mechanism 152 and a rotary actuator 154. The tube clamping mechanism 152 can clamp the second end portion 204 of the metal tube 200. The rotary actuator 154 is connected to the tube clamping mechanism 152 to drive the tube clamping mechanism 152 to rotate, and the tube clamping mechanism 152 further drives the metal tube 200 to rotate around its central axis A1. For example, the rotary actuator 154 may be a motor, and may drive the tube clamping mechanism 152 to rotate through a belt or a gear.

The second linear actuator 160 can carry the metal tube 200, and linearly drive the metal tube 200 in a direction away from the heating zone Z2. In some examples, the second linear actuator 160 includes a linear sliding rail 162 and a drive motor 164. The linear sliding rail 162 can carry the metal tube 200. The drive motor 164 is connected to the linear sliding rail 162 and can drive the linear sliding rail 162 to drive the metal tube 200 thereon. The second rotating mechanism 150 may be disposed on the linear sliding rail 162 of the second linear actuator 160 and may be driven by the linear sliding rail 162, for example. Accordingly, the metal tube 200 can linearly move out of the heating zone Z2 while rotating.

In the present embodiment, the first linear actuator 110 and the first rotating mechanism 120 are driven independently, and the second linear actuator 160 and the second rotating mechanism 150 are also driven independently, such that the movement and the rotation of the metal tube 200 can be effectively controlled, and the heating efficiency of the metal tube 200 can be increased, thereby enhancing the quality of the metal tube 200. In addition, the first rotating mechanism 120 in the feeding zone Z1 and the second rotating mechanism 150 in the discharging zone Z3 can sequentially hold the metal tube 200, such that the continuous heating device 100 is suitable for the heating treatment of long tubes, such as tubes over 4 m.

Referring to FIG. 1 continuously, in some examples, the continuous heating device 100 further includes plural temperature sensors TS. The temperature sensors TS may be only disposed in the heating zone Z2, or may be disposed in the heating zone Z2 and the discharging zone Z3. The temperature sensors TS can sense the temperature of the metal tube 200 when it is heated in the heating zone Z2 and the temperature of the metal tube 200 when it is cooled in the discharging zone Z3, and generate corresponding temperature signals. The temperature sensors TS may be, for example, a non-contact infrared sensing type to sense the temperature of the surface of the metal tube 200. The temperature sensors TS may be connected to the control device 170 through wired or wireless transmission, so as to transmit the sensed temperature signals of the metal tube 200 to the control device 170. The control device 170 can adjust the output currents of the power supply devices 140b to 143b according to the temperature signals.

In some examples, the continuous heating device 100 further includes plural first deformation suppression modules 180 disposed in the heating zone Z2. For example, the first deformation suppression modules 180 are respectively disposed between the heating modules 140 to 143, and between the feeding zone Z1 and the heating module 140 adjacent to the feeding zone Z1. The first deformation suppression modules 180 can suppress the deformation of the metal tube 200 when entering the heating zone Z2 and after being heated by the heating modules 140 to 142. Due to the large difference in temperature during the heating process, the metal tube 200 may be subjected to unnecessary deformation. The first deformation suppression modules 180 can effectively suppress the deformation of the metal tube 200 in the heating zone Z2.

In some examples, the continuous heating device 100 further includes plural second deformation suppression modules 190 sequentially arranged in the discharging zone Z3 to suppress the deformation of the metal tube 200. There will also be a large difference in temperature during the cooling process, which may cause unnecessary deformation of the metal tube 200. Therefore, the second deformation suppression modules 190 can be used to effectively suppress the deformation of the metal tube 200 in the discharging zone Z3.

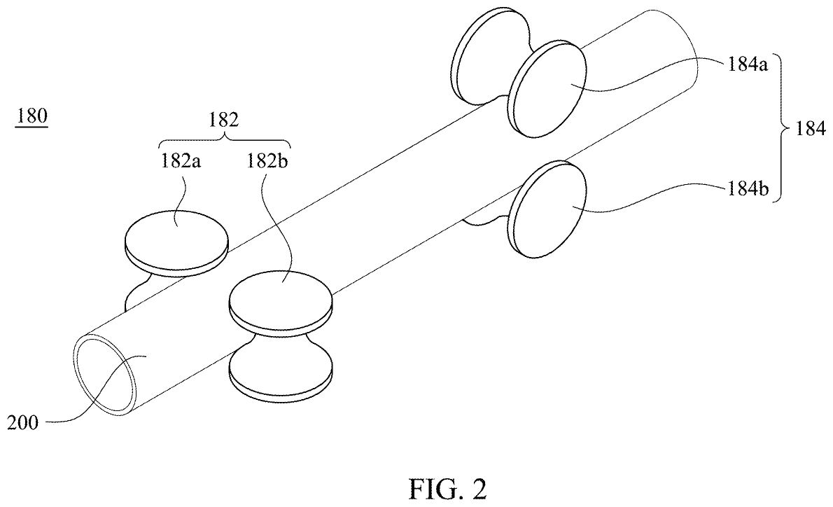

In some examples, the first deformation suppression modules 180 and the second deformation suppression modules 190 have the same structure. The following takes the first deformation suppression module 180 as an example for description. Referring to FIG. 2 to FIG. 4 together, FIG. 2 to FIG. 4 are respectively a schematic three-dimensional diagram of a first deformation suppression module, a schematic cross-sectional view of a first roller set of the first deformation suppression module, and a schematic cross-sectional view of a second roller set of the first deformation suppression module in accordance with one embodiment of the present disclosure. Each of the first deformation suppression modules 180 includes a first roller set 182 and a second roller set 184 arranged in sequence. The first roller set 182 and the second roller set 184 may be adjacent to each other.

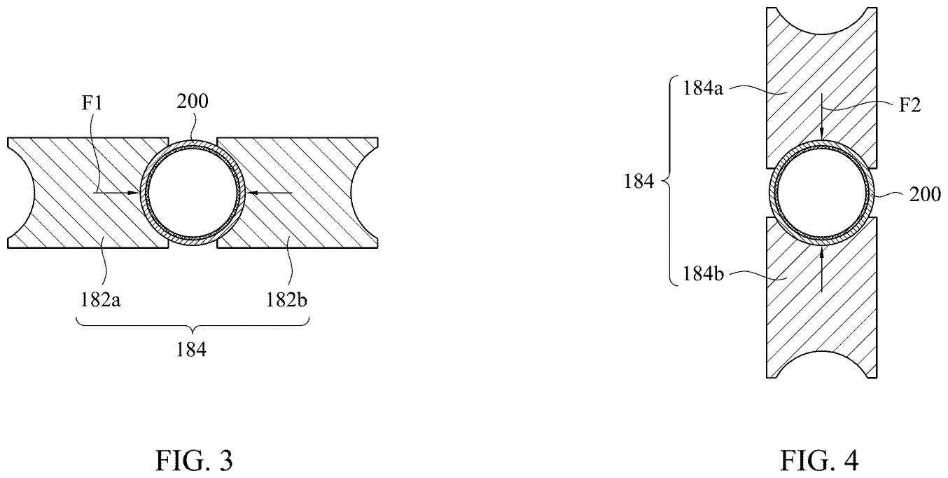

As shown in FIG. 3 and FIG. 4, the first roller set 182 can apply a first suppression force F1 on the metal tube 200, and the second roller set 184 can apply a second suppression force F2 on the metal tube 200. In some exemplary examples, a direction of the first suppression force F1 is substantially perpendicular to a direction of the second suppression force F2. Specifically, the first roller set 182 includes rollers 182a and 182b, and the second roller set 184 includes rollers 184a and 184b, in which a phase difference between a line connecting centers of the rollers 182a and 182b and a line connecting centers of the rollers 184a and 184b is 90 degrees. For example, the rollers 182a and 182b may be spaced apart laterally, and the rollers 184a and 184b may be spaced apart vertically. A distance between the centers of the rollers 182a and 182b and a distance between the centers of the rollers 184a and 184b can be adjusted, such that surfaces of the rollers 182a and 182b and surfaces of the rollers 184a and 184b can accurately contact an outer surface of the metal tube 200.

The second deformation suppression module 190 also includes a first roller set 192 and a second roller set 194. The configurations of rollers of the first roller set 192 and the second roller set 194 are the same as those of the first roller set 182 and the second roller set 184 described above, and will not be repeated herein.

Referring to FIG. 1 again, in some examples, the continuous heating device 100 further includes a blowing module BM disposed in the discharging zone Z3. The blowing module BM can blow on the metal tube 200 to reduce the temperature of the metal tube 200. For example, the blowing module BM can be an elongated tubular structure, the elongated tubular structure is provided with plural gas holes, and the cold air can be blown to the metal tube 200 from the gas holes.

The continuous heating device 100 may also optionally include a second gas introduction mechanism 132. The second gas introduction mechanism 132 is disposed in the discharging zone Z3. When the second rotating mechanism 150 clamps the second end portion 204 of the metal tube 200, the second gas introduction mechanism 132 can supply the process gas required for the heating treatment into the metal tube 200 from the second end portion 204 of the metal tube 200. The second gas introduction mechanism 132 may be, for example, a gas conduit.

In some examples, continue to refer to FIG. 1, when a continuous heating process, such as a sintering process, is performed on a long object, such as the metal tube 200, the first linear actuator 110 and the first rotating mechanism 120 in the feeding zone Z1, and the second rotating mechanism 150 and the second linear actuator 160 in the discharging zone Z3 may be used to transport the metal tube 200 from the feeding zone Z1 to the heating zone Z2 and the discharging zone Z3 in sequence. When transporting the metal tube 200, the first rotating mechanism 120 and the second rotating mechanism 150 may be used to rotate the metal tube 200, such that the metal tube 200 can rotate around its central axis. In some exemplary examples, a rotating speed of rotating the metal tube 200 is about 0.1 rpm to about 1000 rpm. When the metal tube 200 has left the heating zone Z2, the second rotating mechanism 150 can stop rotating the metal tube 200.

During transporting the metal tube 200, the process gas may be introduced into the metal tube 200 from the first end portion 202 of the metal tube 200 by using the first gas introduction mechanism 130. The process gas may include an inert gas and/or a redox gas. For example, the process gas may include nitrogen, argon, and/or hydrogen. When the second rotating mechanism 150 clamps the second end portion 204 of the metal tube 200, the second gas introduction mechanism 132 may continuously supply the process gas required for the heating treatment to the metal tube 200 from the second end portion 204 of the metal tube 200 until the heating is completed.

While rotating and transporting the metal tube 200 and introducing the process gas, a multi-stage heating treatment is performed on the metal tube 200 in the heating zone Z2, so as to heat the metal tube 200 with various heating temperatures. Using the multi-stage heating treatment, the metal material layer coated on the inner surface of the metal tube 200 can be sintered. In some examples, the heating modules 140 to 143 can be used to heat the metal tube 200 during the multi-stage heating treatment, and the heating temperatures of the heating modules 140 to 143 can be individually controlled. For example, when individually controlling the heating temperatures of the heating modules 140 to 143, the current applied to the corresponding induction heating coils 140a to 143a by the power supply devices 140b to 143b of the heating modules 140 to 143 can be adjusted.

In some exemplary examples, when performing the multi-stage heating treatment, plural temperature sensors TS in the heating zone Z2 may be used to sense the temperature of the metal tube 200 to obtain corresponding temperature signals. Next, the control device 170 is used to receive the temperature signals from the temperature sensors TS. Then, the current applied by the power supply devices 140b to 143b to the induction heating coils 140a to 143a is adjusted by the control device 170 according to the temperature signals. For example, the current applied to the induction heating coils 140a to 143a may be a high-frequency current with a frequency of about 10 Hz to about 200 kHz.

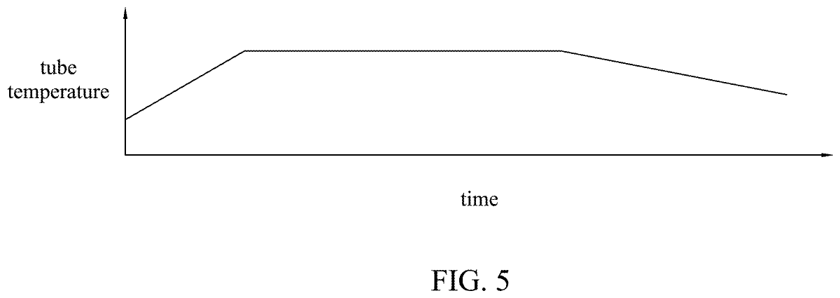

Referring to FIG. 5, FIG. 5 is a diagram showing a temperature variation graph of a metal tube in accordance with one embodiment of the present disclosure.

In some examples, computer aided engineering (CAE) may be used to simulate the heating process to generate initial process parameters. Next, it is repeatedly corrected through experiments until better process parameters are obtained. According to the process parameters, a temperature variation graph of the metal tube 200 is drawn, as shown in FIG. 5. Subsequently, the current applied to the corresponding induction heating coils 140a to 143a by the power supply devices 140b to 143b may be adjusted according to the temperature variation graph of the metal tube 200. Therefore, the temperature of the metal tube 200 can be increased with a better heating energy until the metal material layer in the metal tube 200 is in a suitable range above a melting point of the material, and maintained at a constant temperature for a period of time, and then gradually reduced.

In some examples, during the multi-stage heating treatment, several multiple first deformation suppression treatments may be performed on the metal tube 200 at different positions by using plural first deformation suppression modules 180. Thus, it can prevent unnecessary deformation of the metal tube 200 due to excessive temperature difference during the heating process.

After the multi-stage heating treatment, the metal tube 200 can be cooled in the discharging zone Z3, such that the metal tube 200 can be blown with cold air by the blowing module BM to gradually reduce the temperature of the metal tube 200. In some examples, during the cooling process, several second deformation suppression treatments may be performed on the metal tube 200 at different positions by using plural second deformation suppression modules 190. Accordingly, it can prevent unnecessary deformation of the metal tube 200 due to excessive temperature difference in the cooling process.

According to the aforementioned examples, one advantage of the present disclosure is that a feeding zone and a discharging zone of a continuous heating device of the present disclosure are both provided with independently driven linear actuators and rotating mechanisms, the two rotating mechanisms can continuously rotate a metal tube in a heating zone, and the two linear actuators can sequentially transport the metal tube. Thus, the feeding, heating, and discharging of the metal tube can be carried out continuously, so the efficiency of a heating treatment of the metal tube can be greatly enhanced.

Another advantage of the present disclosure is that a continuous heating method of the present disclosure can perform a multi-stage heating treatment on the metal tube, such that a heating graph of the heating zone can be flexibly set to provide a large constant temperature zone. With a specific heating graph, high-speed heating and proper cooling after heating can be achieved, such that the energy utilization efficiency can be enhanced, the heating efficiency and throughput can be increased, and a porous surface metal tube with high heat transferring quality can be obtained.

Still another advantage of the present disclosure is that a continuous heating device of the present disclosure is a non-furnace open heating device, such that no vacuum treatment is required, and a heating length of the metal tube is not limited by a length of a furnace, which can shorten the process time and reduce the process cost.

Although the present disclosure has been disclosed above with embodiments, it is not intended to limit the present disclosure. Any person having ordinary skill in the art can make various changes and modifications without departing from the spirit and scope of the present disclosure. Therefore, the protection scope of the present disclosure should be defined by the scope of the appended claims.

What is claimed is:

1. A continuous heating device, which is at least divided into a feeding zone, a heating zone, and a discharging zone which are sequentially arranged, and the continuous heating device comprising:
a first linear actuator disposed in the feeding zone, and configured to drive a metal tube linearly towards the heating zone, wherein the metal tube has a first end portion and a second end portion, which are opposite to each other;
a first rotating mechanism disposed in the feeding zone, and configured to clamp the first end portion of the metal tube and to drive the metal tube to rotate on the first linear actuator and in the heating zone;
a first gas introduction mechanism disposed in the feeding zone and configured to supply a process gas into the metal tube from the first end portion of the metal tube;
a plurality of heating modules arranged sequentially in the heating zone, wherein each of the heating modules is configured to heat the metal tube at an individual heating temperature in the heating zone;
a second rotating mechanism disposed in the discharging zone, and configured to clamp the second end portion of the metal tube transported from the heating zone by the first rotating mechanism and to drive the metal tube to rotate in the heating zone and the discharging zone; and
a second linear actuator disposed in the discharging zone, and configured to drive the metal tube linearly away from the heating zone.

2. The continuous heating device of claim 1, wherein
each of the first linear actuator and the second linear actuator comprises a linear sliding rail and a drive motor, wherein the drive motor is connected to the linear sliding rail to drive the linear sliding rail to drive the metal tube; and
each of the first rotating mechanism and the second rotating mechanism comprises a tube clamping mechanism and a rotary actuator, wherein the rotary actuator is connected to the tube clamping mechanism to drive the tube clamping mechanism to rotate, and the tube clamping mechanism is configured to clamp the metal tube and to drive the metal tube to rotate.

3. The continuous heating device of claim 1, wherein each of the heating modules comprises:
an induction heating coil; and
a power supply device electrically connected to the induction heating coil, wherein each of the heating module heats the metal tube at the individual heating temperature through adjusting a current applied to the induction heating coil by the power supply device.

4. The continuous heating device of claim 3, wherein the current is a high-frequency current with a frequency of 10 Hz to 200 kHz.

5. The continuous heating device of claim 1, further comprising a plurality of first deformation suppression modules located in the heating zone, wherein the first deformation suppression modules are respectively disposed between the heating modules, and between the feeding zone and the heating module adjacent to the feeding zone, so as to suppress deformation of the metal tube.

6. The continuous heating device of claim 5, wherein each of the first deformation suppression modules comprises a first roller set and a second roller set arranged in sequence, the first roller set is configured to apply a first suppression force on the metal tube, the second roller set is configured to apply a second suppression force on the metal tube, and a direction of the first suppression force is substantially perpendicular to a direction of the second suppression force.

7. The continuous heating device of claim 1, further comprising a plurality of temperature sensors disposed in the heating zone, or in the heating zone and the discharging zone, to detect a temperature of the metal tube.

8. The continuous heating device of claim 1, further comprising a blowing module disposed in the discharging zone, wherein the blowing module is configured to reduce a temperature of the metal tube.

9. A continuous heating method, comprising:
transporting a metal tube from a feeding zone to a heating zone and a discharging zone sequentially, wherein transporting the metal tube to the heating zone and the discharging zone sequentially comprises rotating the metal tube with a central axis of the metal tube as a rotation axis;
supplying a process gas into the metal tube from a first end portion of the metal tube during transporting the metal tube;
performing a multi-stage heating treatment on the metal tube in the heating zone to heat the metal tube at a plurality of heating temperatures so as to perform a sintering process on a metal material layer coated on an inner surface of the metal tube; and
performing a cooling treatment on the metal tube in the discharging zone.

10. The continuous heating method of claim 9, wherein a rotating speed of rotating the metal tube is 0.1 rpm to 1000 rpm.

11. The continuous heating method of claim 9, wherein the process gas comprises an inert gas and/or a redox gas.

12. The continuous heating method of claim 9, wherein performing the multi-stage heating treatment comprises:
heating the metal tube by using a plurality of heating modules; and
controlling heating temperatures of the heating modules individually.

13. The continuous heating method of claim 12, wherein each of the heating modules comprises an induction heating coil and a power supply device electrically connected to the induction heating coil, and performing the multi-stage heating treatment comprises:
detecting a temperature of the metal tube to obtain a plurality of temperature signals by using a plurality of temperature sensors;
receiving the temperature signals by using a control device; and
adjusting a current applied by each of the power supply devices to the induction heating coil by the control device according to the temperature signals.

14. The continuous heating method of claim 9, wherein performing the multi-stage heating treatment comprises performing a plurality of first deformation suppression treatments on the metal tube.

15. The continuous heating method of claim 9, further comprising performing a plurality of second deformation suppression treatments on the metal tube in the discharging zone.
